(19) United States
(12) Patent Application Publication
(10) Pub. No.: US 2004/0016367 A1
(43) Pub. Date: Jan. 29, 2004

(54) Aqueous ink composition and ink jet recording process

(75) Inventors: Yoshiyuki Koike, Nagano (JP); Hiroshi Ito, Nagano (JP)

Correspondence Address: WILLIAM R. EVANS, c/o LADAS & PARRY, 26 WEST 61ST STREET, NEW YORK, NY, 10023, US

(73) Assignee: SEIKO EPSON CORPORATION

(21) Appl. No.: 10/386,166

(22) Filed: Mar. 10, 2003

(30) Foreign Application Priority Data
Mar. 12, 2002 (JP) P.2002-067718
Mar. 12, 2002 (JP) P.2002-067728
Mar. 25, 2002 (JP) P.2002-084349
Jun. 27, 2002 (JP) P.2002-188603
Jun. 27, 2002 (JP) P.2002-188604
Jun. 27, 2002 (JP) P.2002-188605

(51) Int. Cl. C09D 11/00; B41J 2/01

(52) U.S. Cl. 106/31.86; 106/31.89; 106/31.75; 106/31.77; 106/31.78; 347/100; 106/31.8

(57) ABSTRACT

The invention provides an aqueous ink composition which contains at least (a) a glycol ether type water-soluble organic solvent, (b) an acetylene glycol type surfactant and (c) a pigment, wherein the pigment has a ratio (B/A) of its dissolution amount (B) in the ink liquid medium at 40° C. to its dissolution amount (A) in the ink liquid medium at 25° C. (A) of from 1 to 10.

### FIELD OF THE INVENTION

The present invention relates to an aqueous ink composition containing a pigment as a colorant and to a process for ink jet recording with the ink composition. The invention further relates to an aqueous ink composition containing an aqueous dispersion of pigment-containing polymer particles and to a process for ink jet recording with the ink composition.

### BACKGROUND OF THE INVENTION

Solvent-based inks have problems concerning influences of the organic solvents on the global environment and working atmosphere, and aqueous inks have hence come to be mainly used. Water-soluble dyes have been used in inks for water-base writing utensils and ink jet printers. However, water-soluble dyes intrinsically have poor resistance to light and gases and, hence, use of the dyes has a drawback concerning the storability of recorded images. Namely, when recorded images are exposed to light such as sunlight or the light of a fluorescent lamp, the water-soluble dyes undergo color fading to impair the image quality. Furthermore, the water-soluble dyes suffer color fading by the action of oxidant gases contained in the air, e.g., ozone, to impair the image quality. Water-soluble dyes further have a problem concerning water resistance.

For overcoming those problems, aqueous inks employing a pigment as a colorant are recently being investigated.

The aqueous pigment inks which have been proposed include a pigment dispersion type ink obtained by dispersing a pigment in water with the aid of a surfactant or water-soluble polymer. A pigment-encapsulated type ink prepared by encapsulating a pigment in a water-insoluble polymer and dispersing the pigment-containing polymer in water has also been proposed.

In producing a pigment-encapsulated type ink, a pigment is generally subjected to particle size reduction (dispersion treatment) in an organic solvent or in a mixed solvent comprising water and an organic solvent, as described in, e.g., JP-A-8-183920 and JP-A-8-2118013. For this ink production, a roll mill, bead mill, high-pressure homogenizer, or the like is used as a dispersion apparatus.

However, it is necessary that materials which withstand the organic solvents to be used should be selected as the materials of members of such apparatus, in particular packings thereof, according to the kinds of the organic solvents. There also is a drawback that the durability of packings in organic solvents is generally lower than the durability thereof in water.

Furthermore, the disassembly and cleaning of the dispersion apparatus necessitate measures, for example, for preventing volatilization of the organic solvent and recovering the organic solvent from the washing wastes. There also is a drawback from the standpoint of working atmosphere that contact of an organic solvent with the skin or inhalation of a volatile ingredient may adversely influence the human body.

In addition, use of a roll mill has a drawback that since the organic solvent volatilizes from the roll surfaces, the material being treated dries and the working atmosphere is contaminated. Use of a bead mill or high-pressure homogenizer has a drawback that it is necessary that the whole apparatus including the feed tank and product tank should be sealed in order to prevent the volatilization of the organic solvent contained in the liquid being treated and that a measure for explosion prevention should be taken for the motor, etc.

As described above, in the case where the liquid to be subjected to a dispersion treatment contains an organic solvent, facilities and measures for the handling of the organic solvent are necessary to equipments ranging from small-scale experimental equipments to large-scale equipments for industrial production. Because of this, there is a desire for the development of a process for producing a pigment-encapsulated type aqueous ink which requires no organic solvent.

A method has hence been proposed which comprises dispersing a solid polymer in water, subsequently adding a pigment thereto, and further conducting a dispersion treatment (see JP-A-8-231906). However, this method has a drawback that it has poor suitability for industrial production. This is because when the solid polymer has an improper composition, it does not disperse in water and it necessitates heating or a dispersion treatment with a more powerful dispersing machine in order to disperse the polymer.

Although such a method in which no organic solvent is used at all is ideal, such a method is difficult to realize. In JP-A-2001-247810 is proposed a method in which a water-insoluble polymer is used as an organic solvent solution in order to disperse the polymer in water and to effectively contact it with a pigment, and the organic solvent is removed with taking an equipment measure in a stage prior to a dispersion step, in which an equipment measure can be relatively easily taken. Since no organic solvent is used in the dispersion step, it becomes easy to take an equipment measure in this method.

The inks containing a pigment as a colorant and the pigment-encapsulated type inks are excellent in the storability of recorded images. However, these inks have a problem concerning the storage stability of the inks per se and, for use as ink jet recording inks, further have a problem concerning ejection stability.

It is thought that in the medium comprising water as the main component, the pigment or the pigment-containing polymer particles are not dissolved therein but dispersed therein as minute particles. Virtually, however, the pigment or polymer particles are partly in a dissolved state due to a solvent ingredient and additives used in the ink. It was confirmed that the dissolution amount has a temperature dependence. There is a problem that a larger temperature dependence makes it ready to cause recrystallization of the dissolved ingredients, and this in turn results in the generation of coarse particles, etc. to cause deterioration of storage stability or ejection stability.

Furthermore, there is a problem that when the dissolution amount of the pigment per se is increased, the water resistance of recorded images is deteriorated.

### SUMMARY OF THE INVENTION

An object of the invention is to provide an aqueous ink composition excellent in storage stability and ejection stability.

Another object of the invention is to provide a process for ink jet recording with the aqueous ink composition.

Other objects and effects of the invention will become apparent from the following description.

Those objects of the invention have been achieved by providing the following aqueous ink compositions and ink jet recording process.

(1) An aqueous ink composition which contains at least (a) a glycol ether type water-soluble organic solvent, (b) an acetylene glycol type surfactant and (c) a pigment, wherein the pigment has a ratio (B/A) of its dissolution amount (B) in the ink liquid medium at 40° C. to its dissolution amount (A) in the ink liquid medium at 25° C. of from 1 to 10.

(2) The aqueous ink composition of item (1) above, wherein the pigment is represented by the following structural formula (A):

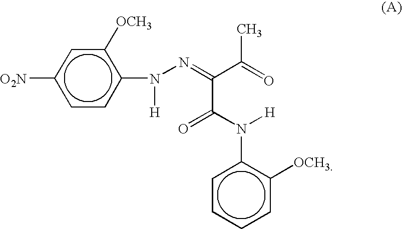

(3) The aqueous ink composition of item (1) above, wherein the pigment is represented by the following structural formula (B):

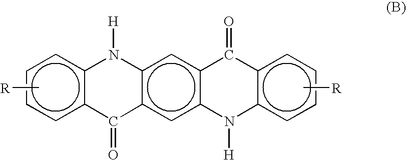

wherein R represents a hydrogen atom, a methyl group, or a chlorine atom.

(4) The aqueous ink composition of item (1) above, wherein the pigment is represented by the following general formula (C):

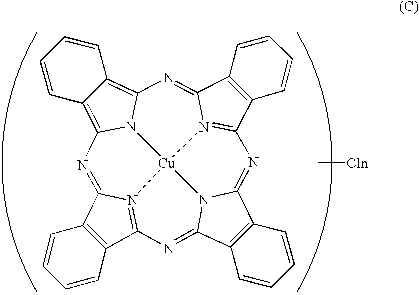

wherein n representing the number of chloride atoms, is from 0 to 16.

(5) The aqueous ink composition of item (2) above, which contains the pigment in the form of an aqueous dispersion of pigment-containing polymer particles, the aqueous dispersion being obtained by a process comprising: (I) a step of removing an organic solvent from a mixture (1) comprising an organic solvent solution of a polymer, water and optionally a neutralizing agent; (II) a step of subjecting the residue resulting from the solvent removal in step (I) to a dispersion treatment; and further adding the compound represented by general formula (A) to either the mixture (1) or the residue resulting from the solvent removal.

(6) The aqueous ink composition of item (3) above, which contains the pigment in the form of an aqueous dispersion of pigment-containing polymer particles, the aqueous dispersion being obtained by a process comprising: (I) a step of removing an organic solvent from a mixture (1) comprising an organic solvent solution of a polymer, water and optionally a neutralizing agent; (II) a step of subjecting the residue resulting from the solvent removal in step (I) to a dispersion treatment; and further adding the compound represented by general formula (B) to either the mixture (1) or the residue resulting from the solvent removal.

(7) The aqueous ink composition of item (4) above, which contains the pigment in the form of an aqueous dispersion of pigment-containing polymer particles, the aqueous dispersion being obtained by a process comprising: (I) a step of removing an organic solvent from a mixture (1) comprising an organic solvent solution of a polymer, water and optionally a neutralizing agent; (II) a step of subjecting the residue resulting from the solvent removal in step (I) to a dispersion treatment; and further adding the compound represented by general formula (C) to either the mixture (1) or the residue resulting from the solvent removal.

(8) The aqueous ink composition of item (4) above, wherein the ink composition, when the solid matter contained in the aqueous ink composition at 25° C. is sedimented by centrifuging, gives a supernatant having an absorbance (peak absorbance value in the visible light region at an optical path length of 10 mm without dilution) of 4 or lower.

(9) The aqueous ink composition of item (5) above, wherein the ink composition, when the solid matter contained in the aqueous ink composition at 25° C. is sedimented by centrifuging, gives a supernatant having an absorbance (peak absorbance value in the visible light region at an optical path length of 10 mm without dilution) of 6 or lower.

(10) The aqueous ink composition of item (6) above, wherein the ink composition, when the solid matter contained in the aqueous ink composition at 25° C. is sedimented by centrifuging, gives a supernatant having an absorbance (peak absorbance value in the visible light region at an optical path length of 10 mm without dilution) of 5 or lower.

(11) The aqueous ink composition of item (7) above, wherein the ink composition, when the solid matter contained in the aqueous ink composition at 25° C. is sedimented by centrifuging, gives a supernatant having an absorbance (peak absorbance value in the visible light region at an optical path length of 10 mm without dilution) of 4 or lower.

(12) An ink jet recording process which comprises ejecting an ink composition in the form of droplets from a minute nozzle to adhere the droplets to a recording medium, wherein the ink composition is an aqueous ink composition of any one of items (1) to (11) above.

The aqueous ink composition of the invention has excellent storage stability and can show preferred properties including excellent ejection stability in the ink jet printing process of the invention.

However, in case where the B/A ratio is far higher than 10, the storage stability and ejection stability of the ink deteriorate depending on the atmosphere in which the ink is stored or used in printing. Furthermore, since too large pigment dissolution amounts result in deteriorated water resistance of recorded images, the amount of the pigment dissolved is preferably such that when the solid matter contained in the aqueous ink composition at 25° C. is sedimented by centrifuging, the composition gives a supernatant having an absorbance (peak absorbance value in the visible light region at an optical path length of 10 mm without dilution) not higher than the values specified in items (8) to (11) above.

### DETAILED DESCRIPTION OF THE INVENTION

The dissolution amount ratio (B/A) for the pigment in the liquid medium will be explained first.

After an ink is produced in a 25° C. room atmosphere, the ink is treated with a centrifugal separator at a rotational speed of 80,000 rpm for 2 hours to centrifugally sediment the solid matter contained in the aqueous ink composition. Thereafter, the supernatant is taken out. The supernatant taken out is diluted with pure water to a concentration suitable for examination with a spectrophotometer, and then examined for absorbance.

Furthermore, the ink produced in a 25° C. room atmosphere is allowed to stand in a 40° C. atmosphere for 1 week. Thereafter, a supernatant is obtained therefrom through centrifugal sedimentation and diluted in the same manner as described above, and the diluted supernatant is examined for absorbance.

These values of absorbance are proportional to the amount of the pigment dissolved. Consequently, by dividing the absorbance of the supernatant obtained after 40° C. standing by the absorbance of the supernatant obtained after 25° C. standing, the dissolution amount ratio (B/A) for the pigment in the liquid medium can be determined.

For the purpose of confirming that the coloring agent in the supernatant is wholly comprised of the dissolved pigment, those supernatants were examined with Microtrac UPA Particle Size Analyzer (trade name; manufactured by Leeds & Northrup Company) employing scattered laser Doppler light to ascertain the absence of particles larger than the primary-particle diameter.

The aqueous dispersion of a pigment-containing polymer will be explained next.

As the polymer for use in the organic solvent solution of a polymer can be used a water-insoluble polymer capable of containing a pigment therein. Examples of the polymer include vinyl polymers, polyester polymers, and polyurethane polymers. Preferred of these polymers are vinyl polymers. Examples of the vinyl polymers include polymers of one or more monomers selected from the group consisting of styrene, (meth)acrylic acid, and (meth) acrylic esters. Such polymers each preferably have a weight-average molecular weight of from 3,000 to 50,000 from the standpoints of enhancing ink durability after printing and of preventing the aqueous ink in the case of application to ink jet recording from scorching and sticking to the printer head in a recording process in which the ink is abruptly expanded by the action of heat energy and ejected based on this expansion.

The polymer preferably has a salt-forming group. In this case, a neutralizing agent for neutralizing the polymer having a salt-forming group can be used according to need.

As the neutralizing agent can be used an acid or a base according to the kind of the salt-forming group. Examples of the acid include inorganic acids such as hydrochloric acid and sulfuric acid and organic acids such as acetic acid, propionic acid, lactic acid, succinic acid, glycolic acid, gluconic acid, and glyceric acid. Examples of the base include tertiary amines such as trimethylamine and triethylamine, ammonia, sodium hydroxide, and potassium hydroxide. Although the amount of the neutralizing agent is not particularly limited, it is generally preferred to regulate the aqueous dispersion obtained so as to be neutral, e.g., have a pH of from 4.5 to 9.

Preferred examples of the organic solvent include alcohol solvents, ketone solvents, ether solvents, aromatic hydrocarbon solvents, aliphatic hydrocarbon solvents, and halogenated aliphatic hydrocarbon solvents. More preferred are hydrophilic organic solvents.

Examples of the alcohol solvents include methanol, ethanol, isopropanol, n-butanol, tert-butanol, isobutanol, and diacetone alcohol. Examples of the ketone solvents include acetone, methyl ethyl ketone, diethyl ketone, and methyl isobutyl ketone. Examples of the ether solvents include dibutyl ether, tetrahydrofuran, and dioxane. Examples of the aromatic hydrocarbon solvents include benzene and toluene. Examples of the aliphatic hydrocarbon solvents include heptane, hexane, and cyclohexane. Examples of the halogenated aliphatic hydrocarbon solvents include methylene chloride, 1,1,1-trichloroethane, chloroform, carbon tetrachloride, and 1,2-dichloroethane. Preferred of these are acetone and methyl ethyl ketone.

The concentration of the polymer in the organic solvent solution thereof is not particularly limited. However, it is generally preferably about from 1 to 60% by weight.

The amount of the water is desirably from 100 to 1,000 parts by weight, preferably from 200 to 500 parts by weight, per 100 parts by weight of the organic solvent used for the organic solvent solution of the polymer, from the standpoint of forming an aqueous phase as a continuous phase.

The process for producing the aqueous dispersion of pigment-containing polymer will be explained next.

First, in step (I), from a mixture (1) comprising an organic solvent solution of a polymer and water and optionally containing a neutralizing agent, the organic solvent is removed.

The mixture (1) can be obtained by mixing an organic solvent solution of a polymer with water and optionally further with a neutralizing agent by means of an ordinary mixing/stirring apparatus equipped with an anchor blade, turbine impeller, or the like.

There are no particular limitations on the method for removing the organic solvent from the mixture (1). A preferred method for removing the organic solvent is the vacuum distillation method, in particular, the thin-film type vacuum distillation method. Although the amount of the organic solvent to be removed is not particularly limited, it is generally preferred to remove all the organic solvent.

Subsequently, in step (II), the residue resulting from the solvent removal in step (I) is subjected to a dispersion treatment. For the dispersion treatment can be used a ball mill, roll mill, bead mill, high-pressure homogenizer, high-speed agitation type disperser, or the like. Preferred of these is a high-pressure homogenizer because inclusion of inorganic impurities is little with this apparatus.

Examples of the high-pressure homogenizer include one in which the passage of the liquid to be treated has a fixed chamber and one in which the passage of the liquid to be treated has a homogeneous valve whose width can be controlled. Examples of the high-pressure homogenizer in which the passage of the liquid to be treated has a fixed chamber include Microfluidizer (trade name; manufactured by Microfluidisc), Nanomizer (trade name; manufactured by Nanomizer Inc.), and Ultimizer (trade name; manufactured by Sugino Machine Ltd.). Examples of the high-pressure homogenizer having a homogeneous value include High-Pressure Homogenizer (trade name; manufactured by Raney), High-Pressure Homogenizer (trade name; manufactured by Sanmaru Kikai Kogyo K.K.), and High-Pressure Homogenizer (trade name; manufactured by Izumi Food Machinery Co., Ltd.).

The pressure in the dispersion with a high-pressure homogenizer is preferably 50 MPa or higher, more preferably 80 MPa or higher, from the standpoint of obtaining polymer particles having a desired particle diameter in a short time period.

In the process for producing the aqueous dispersion of a pigment-containing polymer according to the invention, a pigment is added to and mixed with either the mixture (1) or the residue resulting from solvent removal. This mixing can be accomplished with a high-speed rotation type agitator such as, e.g., a Disper.

The average particle diameter of the polymer particles contained in the aqueous dispersion of pigment-containing polymer particles is preferably from 0.01 to 0.50 μm, more preferably from 0.02 to 0.20 μm, from the standpoints of preventing the aqueous ink from blurring and of attaining dispersion stability. According to need, coarse particles may be removed from the pigment-containing polymer particle dispersion by centrifugal separation, filtration, etc.

By the process described above, the desired aqueous dispersion of pigment-containing polymer particles can be obtained.

The aqueous ink composition of the invention will be explained below in detail.

It is desirable that a penetration accelerator such as water-soluble organic solvent and a surfactant, which reduce surface tension, be added to the aqueous ink composition of the invention to improve the ability to wet recording media and accelerate penetration. Thus, drying properties on recording media are improved and color mixing/blurring is inhibited. Examples of the water-soluble organic solvent include lower alcohols such as ethanol and propanol, Cellosolves such as ethylene glycol monomethyl ether and ethylene glycol monoethyl ether, Carbitols such as diethylene glycol monomethyl ether and diethylene glycol monoethyl ether, and 1,2-alkyldiols such as 1,2-octanediol. As the surfactant can be used anionic surfactants such as fatty acid salts and alkyl sulfate salts, nonionic surfactants such as polyoxyethylene alkyl ethers and polyoxyethylene phenyl ether, cationic surfactants, amphoteric surfactants, and the like. In particular, nonionic surfactants are suitable because they are less apt to cause ink frothing than ionic surfactants.

Those penetration accelerators, i.e., water-soluble organic solvents or surfactants, may be added alone or in combination desirably so as to regulate the surface tension of the ink to below 40 dyn/cm, preferably below 35 dyn/cm.

More preferred penetration accelerators are glycol ether type water-soluble organic solvents, and examples thereof include ethylene glycol mono-n-butyl ether, diethylene glycol mono-n-butyl ether, and triethylene glycol mono-n-butyl ether. Preferred surfactants among nonionic surfactants are acetylene glycol type surfactants such as Surfynol 61, 82, 104, 440, 465, and 485 (all are trade names; manufactured by Air Products and Chemicals, Inc.). Such acetylene glycol type surfactants are especially suitable for ink jet recording because an ink almost free from frothing can be obtained therewith.

A humectant is desirably added to the aqueous ink composition to be used in the ink jet recording process of the invention, for the purpose of preventing the ink from drying at the tip of the ink ejection nozzle. The humectant is selected from materials which are water-soluble and highly hygroscopic. Examples thereof include polyols such as glycerol, ethylene glycol, diethylene glycol, triethylene glycol, polyethylene glycol, propylene glycol, dipropylene glycol, polypropylene glycol, 1,3-propanediol, 1,4-butanediol, 1,5-pentanediol, 1,6-hexanediol, 1,2,6-hexanetriol, and pentaerythritol, lactams such as 2-pyrrolidone, N-methyl-2-pyrrolidone, and ε-caprolactam, urea compounds such as urea, thiourea, ethyleneurea, and 1,3-dimethylimidazolidinone compounds, and saccharides such as maltitol, sorbitol, gluconotactone, and maltose.

Those humectants and other ink additives can be added in such a total amount that the ink has a viscosity at 25° C. of 25 cPs or lower.

Other additives such as a fixing agent, pH regulator, antioxidant/ultraviolet absorber, and antiseptic/antifungal agent can be further added to the aqueous ink composition of the invention according to need.

As the fixing agent can be used a water-soluble resin. Examples thereof include water-soluble rosins, alginic acid compounds, poly(vinyl alcohol), hydroxypropyl cellulose, carboxymethyl cellulose, hydroxyethyl cellulose, methyl cellulose, styrene/acrylic acid resins, styrene/acrylic acid/acrylic ester resins, styrene/maleic acid resins, styrene/maleic acid half-ester resins, acrylic acid/acrylic ester resins, isobutylene/maleic acid resins, rosin-modified maleic acid resins, polyvinylpyrrolidone, gum arabic starch, polyacrylamine, polyvinylamine, and polyethyleneimine.

Examples of the pH regulator include the hydroxides of alkali metals and amines, such as lithium hydroxide, sodium hydroxide, potassium hydroxide, triethanolamine, and diethanolamine.

As the antioxidant/ultraviolet absorber can be used: allophanates such as allophanate and methyl allophanate; buret compounds such s buret, dimethylburet, and tetramethylburet; L-ascorbic acid and salts thereof; Tinuvin 328, 900, 1130, 384, 292, 123, 144, 622, 770, and 292, Irgacor 252 and 153, Irganox 1010, 1076, and 1035, and MD 1024, manufactured by Ciba-Geigy Ltd.; lanthanide oxides; and the like.

The antiseptic/antifungal agent can be selected, for example, from sodium benzoate, sodium pentachlorophenoxide, sodium 2-pyridinethiol 1-oxide, sodium sorbate, sodium dehydroacetate, 1,2-dibenzisothiazolin-3-one (Proxel CRL, Proxel BDN, Proxel GXL, Proxel XL-2, and Proxel TN, manufactured by ICI Ltd.), and the like.

For practicing the ink jet recording process of the invention, any method can be used as long as it comprises ejecting the ink composition in the form of droplets from a minute nozzle to adhere the droplets to a recording medium. Several of such methods will be explained below. A first method is an electrostatic attraction technique. In this technique, an intense electric field is applied between a nozzle and an acceleration electrode disposed ahead of the nozzle to continuously eject ink droplets from the nozzle. The ink droplets are caused to fly between deflection electrodes, during which printing information is given to the deflection electrodes to conduct recording. Alternatively, ink droplets are ejected according to printing information signals without being deflected.

A second method is a technique in which a pressure is applied to the ink with a small pump and the nozzle is mechanically oscillated with a quartz oscillator or the like to thereby forcibly eject ink droplets. The ink droplets ejected are charged simultaneously with the ejection and caused to fly between deflection electrodes, during which printing information signals are given to the deflection electrodes to conduct recording.

A third method is a technique in which a piezoelectric device is used. In this technique, a pressure and printing information signals are simultaneously applied to the ink with a piezoelectric device to eject ink droplets and conduct recording.

A fourth method is a technique in which the ink is abruptly expanded by the action of heat energy. Specifically, the ink is bubbled by heating with minute electrodes according to printing information signals to eject ink droplets and conduct recording.

Any of the ink jet recording techniques described above is used to conduct printing with the aqueous ink composition of the invention. Thus, stable ink jet recording can be conducted.

### EXAMPLES

The invention will be illustrated in greater detail with reference to the following Examples, but the invention should not be construed as being limited thereto.

### Example 1A

Pigment dispersion A was used which had a solid content of the pigment represented by structural formula (A) of 10 wt %.

| | | |
|---|---|---|
| Pigment dispersion A (10 wt %) | 40 | parts by weight |
| Triethylene glycol mono-n-butyl ether | 15 | parts by weight |
| Surfynol 465 | 3 | parts by weight |
| Diethylene glycol | 5 | parts by weight |
| Glycerol | 10 | parts by weight |
| Triethanolamine | 1 | part by weight |
| Proxel XL-2 | 0.1 | part by weight |
| Ultrapure water | 25.9 | parts by weight |

These ingredients were mixed with stirring and the resultant mixture was filtered through a membrane filter having a pore size of 1 μm to obtain an ink.

### Example 2A

| | | |
|---|---|---|
| Pigment dispersion A (10 wt %) | 40 | parts by weight |
| Diethylene glycol mono-n-butyl ether | 10 | parts by weight |
| Surfynol 440 | 1 | part by weight |
| Urea | 5 | parts by weight |
| Glycerol | 10 | parts by weight |
| Potassium hydroxide | 0.1 | part by weight |
| Proxel XL-2 | 0.1 | part by weight |
| Ultrapure water | 33.8 | parts by weight |

These ingredients were mixed with stirring and the resultant mixture was filtered through a membrane filter having a pore size of 1 μm to obtain an ink.

### Example 3A

| | | |
|---|---|---|
| Pigment dispersion A (10 wt %) | 40 | parts by weight |
| Diethylene glycol mono-n-butyl ether | 3 | parts by weight |
| Surfynol 440 | 1 | part by weight |
| Urea | 5 | parts by weight |
| Glycerol | 10 | parts by weight |
| Potassium hydroxide | 0.1 | part by weight |
| Proxel XL-2 | 0.1 | part by weight |
| Ultrapure water | 40.8 | parts by weight |

These ingredients were mixed with stirring and the resultant mixture was filtered through a membrane filter having a pore size of 1 μm to obtain an ink.

### Example 4A

| | | |
|---|---|---|
| Pigment dispersion A (10 wt %) | 40 | parts by weight |
| Diethylene glycol mono-n-butyl ether | 3 | parts by weight |
| Surfynol 465 | 0.1 | part by weight |
| Urea | 5 | parts by weight |
| Glycerol | 10 | parts by weight |
| Potassium hydroxide | 0.1 | part by weight |
| Proxel XL-2 | 0.1 | part by weight |
| Ultrapure water | 41.7 | parts by weight |

These ingredients were mixed with stirring and the resultant mixture was filtered through a membrane filter having a pore size of 1 μm to obtain an ink.

In Examples 1A to 4A, the ratio (B/A) of the dissolution amount (B) of the pigment in the liquid medium at 40° C. to the dissolution amount (A) of the pigment in the liquid medium at 25° C. was ascertained to be in the range of from 1 to 10.

### Comparative Example 1A

The same ingredients as in Example 1A were used, except that the amounts of triethylene glycol mono-n-butyl ether and Surfynol 465 to be added were increased to 25 parts by weight and 5 parts by weight, respectively, so as to regulate the ratio (B/A) of the dissolution amount (B) of the pigment in the liquid medium at 40° C. to the dissolution amount (A) of the pigment in the liquid medium at 25° C. to 10 or greater, and that the increase in the amounts of these was compensated for by changing the amount of ultrapure water to be added. The ingredients were mixed with stirring and filtered through a membrane filter having a pore size of 1 μm, in the same manner as in the Example, to obtain an ink.

### Comparative Example 2A

The same ingredients as in Example 2A were used, except that the amounts of diethylene glycol mono-n-butyl ether and Surfynol 440 to be added were increased to 20 parts by weight and 5 parts by weight, respectively, so as to regulate the ratio (B/A) of the dissolution amount (B) of the pigment in the liquid medium at 40° C. to the dissolution amount (A) of the pigment in the liquid medium at 25° C. to 10 or greater, and that the increase in the amounts of these was compensated for by changing the amount of ultrapure water to be added. The ingredients were mixed with stirring and filtered through a membrane filter having a pore size of 1 μm, in the same manner as in the Example, to obtain an ink.

### Comparative Example 3A

The same ingredients as in Example 4 were used, except that the amounts of diethylene glycol mono-n-butyl ether and Surfynol 465 to be added were increased to 20 parts by weight and 5 parts by weight, respectively, so as to regulate the ratio (B/A) of the dissolution amount (B) of the pigment in the liquid-medium at 40° C. to the dissolution amount (A) of the pigment in the liquid medium at 25° C. to 10 or greater, and that the increase in the amounts of these was compensated for by changing the amount of ultrapure water to be added. The ingredients were mixed with stirring and filtered through a membrane filter having a pore size of 1 μm, in the same manner as in the Example, to obtain an ink.

<Evaluation Methods>

Storage Stability

The ink compositions obtained in Examples 1A to 4A and Comparative Examples 1 to 3 each were placed in a sample container made of polypropylene. The containers were covered airtightly and allowed to stand in this state in a 70° C. atmosphere for 1 week. The particle size distribution of each ink composition before the 70° C. standing was compared with that of the composition after the standing. The ink compositions were compared in change in average particle diameter and increase in coarse particles. For the particle diameter measurement was used Microtrac UPA Particle Size Analyzer (trade name; manufactured by Leeds & Northrup Company) employing scattered laser Dopper light.

After the standing at 70° C., each ink was examined for foreign matter (coarse particles) through filtration through a membrane filter having a pore size of 1 μm.

Ejection Stability

The ink compositions obtained in Examples 1A to 4A and Comparative Examples 1A to 3A were subjected to a continuous printing test with piezoelectric device type on-demand ink jet printer Stylus C80 (trade name; manufactured by Seiko Epson Corp.). Each ink was set on Stylus C80 and allowed to stand in a 40° C. atmosphere for 1 week. Thereafter, continuous printing was conducted in a 25° C. atmosphere and the printed matter was examined for ink droplet flight deflection and for dot missing caused by dotting failure. The nozzle surface was examined thereafter.

The results obtained are summarized in Table 1A.

TABLE 1A

| | Storage Stability | | | | | | | |
|---|---|---|---|---|---|---|---|---|
| | | Percentage | | | | | | |
| | | increase in | | | | | | |
| | Dissolution | average | Increase in | Foreign | Ejection Stability | | | |
| | amount ratio, | particle | coarse | matter of 1 | Flight | | Wetting | |
| | B/A | diameter | particles | μm | deflection | Dot missing | around nozzle | Foreign matter |
| Example 1A | 7.1 | 9% | not occurred | absent | not occurred | not occurred | not occurred | absent |
| Example 2A | 4.2 | 5% | not occurred | absent | not occurred | not occurred | not occurred | absent |
| Example 3A | 2.1 | 2% | not occurred | absent | not occurred | not occurred | not occurred | absent |
| Example 4A | 1.3 | 1% | not occurred | absent | not occurred | not occurred | not occurred | absent |
| Comparative | 12.1 | 48% | occurred | present | occurred | occurred | occurred | present |
| Example 1A | | | | | | | | |
| Comparative | 10.7 | 40% | occurred | present | occurred | occurred | occurred | present |
| Example 2A | | | | | | | | |
| Comparative | 10.8 | 39% | occurred | present | occurred | occurred | occurred | present |
| Example 3A | | | | | | | | |

The ink compositions of Examples 1A to 4A gave satisfactory results in each evaluation, showing that these compositions were highly excellent. The compositions of Comparative Examples 1A to 3A each gave unsatisfactory results in each evaluation. In the evaluation of storage stability, the average particle diameter increased by more than 20%, and an increase in the amount of course particles and the generation of foreign matter caught by the 1-μm filter were observed. In the evaluation of ejection stability, ink droplet flight deflection and dot missing occurred. In the nozzle surface examination, wetting around the nozzle and foreign-matter deposition within the nozzle were observed.

### Examples 1B to 4 B and Comparative Examples 1B to 3B

Of the pigments for use in the invention, the pigment represented by general formula (B) wherein R is methyl was used to prepare pigment dispersion B having a pigment solid content of 10 wt %. This dispersion was used.

The pigment dispersion B was produced by the following process.

In 71.2 parts by weight of ultrapure water were completely dissolved, with heating at 70° C., 5 parts by weight of a styrene/acrylic acid copolymer resin (Joncryl 550; weight-average molecular weight, 7,500; acid value, 200), 3.4 parts by weight of triethanolamine, and 0.4 parts by weight of isopropyl alcohol.

Subsequently, 20 parts by weight of the pigment was added to the solution and premixing was conducted. This mixture was treated with Eiger Mill (manufactured by Eiger Japan) to disperse the pigment until the average particle diameter thereof became 120 nm (bead packing ratio, 70%; medium diameter, 0.7 mm), and then diluted to a pigment solid content of 10 wt %. Thus, the target pigment dispersion was obtained.

Inks of Examples 1B to 4B and Comparative Examples 1B to 3B were obtained in the same manner as in Examples 1A to 4A and Comparative Examples 1A to 3A, except that the pigment dispersion B was used in place of pigment dispersion A.

In Examples 1B to 4B, the ratio (B/A) of the dissolution amount (B) of the pigment in the liquid medium at 40° C. to the dissolution amount (A) of the pigment in the liquid medium at 25° C. was ascertained to be in the range of from 1 to 10.

The ink compositions obtained in Examples 1B to 4B and Comparative Examples 1B to 3B were evaluated for storage stability and ejection stability in the same manners as in Examples 1A to 4A and Comparative Examples 1A to 3A. The results obtained are summarized in Table 1B.

TABLE 1B

| | Storage Stability | | | | | | | |
|---|---|---|---|---|---|---|---|---|
| | | Percentage | | | | | | |
| | | increase in | | | | | | |
| | Dissolution | average | Increase in | Foreign | Ejection Stability | | | |
| | amount ratio, | particle | coarse | matter of 1 | Flight | | Wetting | |
| | B/A | diameter | particles | μm | deflection | Dot missing | around nozzle | Foreign matter |
| Example 1B | 7.0 | 10% | not occurred | absent | not occurred | not occurred | not occurred | absent |
| Example 2B | 4.3 | 5% | not occurred | absent | not occurred | not occurred | not occurred | absent |
| Example 3B | 2.0 | 3% | not occurred | absent | not occurred | not occurred | not occurred | absent |
| Example 4B | 1.5 | 1% | not occurred | absent | not occurred | not occurred | not occurred | absent |
| Comparative | 12.5 | 49% | occurred | present | occurred | occurred | occurred | present |
| Example 1B | | | | | | | | |
| Comparative | 10.5 | 39% | occurred | present | occurred | occurred | occurred | present |
| Example 2B | | | | | | | | |
| Comparative | 10.9 | 40% | occurred | present | occurred | occurred | occurred | present |
| Example 3B | | | | | | | | |

The ink compositions of Examples 1B to 4B gave satisfactory results in each evaluation, showing that these compositions were highly excellent because B/A was in the range of from 1 to 10. The smaller the value of B/A, the better the evaluation results. B/A is preferably from 1 to 5, more preferably from 1 to 2.

The compositions of Comparative Examples 1B to 3B each gave unsatisfactory results in each evaluation. In the evaluation of storage stability, the average particle diameter increased by more than 20%, and an increase in the amount of course particles and the generation of foreign matter caught by the 1-μm filter were observed. In the evaluation of ejection stability, ink droplet flight deflection and dot missing occurred. In the nozzle surface examination, wetting around the nozzle and foreign-matter deposition within the nozzle were observed.

Each of those troubles is a phenomenon which can occur in actual use environments. A pigment component which has dissolved serves to bond pigment particles to one another to yield larger particles or form a deposit on the inner wall of the nozzle. Thus, storage stability and ejection stability are deteriorated.

### Examples 1C to 4C and Comparative Examples 1C to 3C

Of the pigments for use in the invention, the pigment represented by general formula (C) wherein n is 0 was used to prepare pigment dispersion C having a pigment solid content of 10 wt %. This dispersion was used.

The pigment dispersion C was produced by the following process.

In 71.2 parts by weight of ultrapure water were completely dissolved, with heating at 70° C., 5 parts by weight of a styrene/acrylic acid copolymer resin (Joncryl 550; weight-average molecular weight, 7,500; acid value, 200), 3.4 parts by weight of triethanolamine, and 0.4 parts by weight of isopropyl alcohol.

Subsequently, 20 parts by weight of the pigment was added to the solution and premixing was conducted. This mixture was treated with Eiger Mill (manufactured by Eiger Japan) to disperse the pigment until the average particle diameter thereof became 120 nm (bead packing ratio, 70%; medium diameter, 0.7 mm), and then diluted to a pigment solid content of 10 wt %. Thus, the target pigment dispersion was obtained.

Inks of Examples 1C to 4C and Comparative Examples 1C to 3C were obtained in the same manner as in Examples 1A to 4A and Comparative Examples 1A to 3A, except that the pigment dispersion C was used in place of pigment dispersion A.

In Examples 1C to 4C, the ratio (B/A) of the dissolution amount (B) of the pigment in the liquid medium at 40° C. to the dissolution amount (A) of the pigment in the liquid medium at 25° C. was ascertained to be in the range of from 1 to 10. Absorbance was measured with spectrophotometer U-3300 (manufactured by Hitachi, Ltd.) in a quartz cell having an optical path length of 10 mm.

The ink compositions obtained in Examples 1C to 4C and Comparative Examples 1C to 3C were evaluated for storage stability and ejection stability in the same manners as in Examples 1A to 4A and Comparative Examples 1A to 3A. The following evaluation of water resistance was further conducted.

Water Resistance

The ink compositions obtained in Examples 1C to 4C and Comparative Examples 1C to 3C were subjected to printing with piezoelectric device type on-demand ink jet recorder Stylus C80 (trade name; manufactured by Seiko Epson Corp.) on plain paper Xerox 4024 (manufactured by Xerox Corp.) in an atmosphere of 25° C. After each printed matter obtained was dried by standing in a room for 1 day, pure water was dropped onto an image area with a dropping pipet and allowed to dry naturally. The mark of the water droplet (water mark) was examined for ink blurring.

The results obtained are summarized in Table 1C.

TABLE 1C

| | Storage Stability | | | | | | | | | |
|---|---|---|---|---|---|---|---|---|---|---|
| | | Percentage | | | | | | | | |
| | | increase in | | | Ejection Stability | | | | Water Resistance | |
| | Dissolution | average | Increase in | Foreign | | | Wetting | | Absorbance | |
| | amount | particle | coarse | matter of 1 | Flight | | around | Foreign | of 25° C. | Blurring in |
| | ratio, B/A | diameter | particles | μm | deflection | Dot missing | nozzle | matter | supernatant | water mark |
| Example 1C | 7.4 | 11% | not occurred | absent | not | not | not | absent | 1.8 | not occurred |
| | | | | | occurred | occurred | occurred | | | |
| Example 2C | 4.3 | 6% | not occurred | absent | not | not | not | absent | 1.5 | not occurred |
| | | | | | occurred | occurred | occurred | | | |
| Example 3C | 2.2 | 3% | not occurred | absent | not | not | not | absent | 1.0 | not occurred |
| | | | | | occurred | occurred | occurred | | | |
| Example 4C | 1.4 | 1% | not occurred | absent | not | not | not | absent | 0.8 | not occurred |
| | | | | | occurred | occurred | occurred | | | |
| Comparative | 12.2 | 47% | occurred | present | occurred | occurred | occurred | present | 4.3 | occurred |
| Example 1C | | | | | | | | | | |
| Comparative | 10.8 | 38% | occurred | present | occurred | occurred | occurred | present | 3.7 | not occurred |
| Example 2C | | | | | | | | | | |
| Comparative | 11.0 | 41% | occurred | present | occurred | occurred | occurred | present | 3.5 | not occurred |
| Example 3C | | | | | | | | | | |

The ink compositions of Examples 1C to 4C gave satisfactory results in each evaluation, showing that these compositions were highly excellent because B/A was in the range of from 1 to 10. The smaller the value of B/A, the better the evaluation results. B/A is preferably from 1 to 5, more preferably from 1 to 2.

The compositions of Comparative Examples 1C to 3C each gave unsatisfactory results in at least one of the evaluations. In the evaluation of storage stability, the average particle diameter increased by more than 20%, and an increase in the amount of course particles and the generation of foreign matter caught by the 1-μm filter were observed. In the evaluation of ejection stability, ink droplet flight deflection and dot missing occurred. In the nozzle surface examination, wetting around the nozzle and foreign-matter deposition within the nozzle were observed. Furthermore, in the evaluation of water resistance, ink blurring was observed in the water mark in the case of the ink composition in which the supernatant had an absorbance (peak absorbance value in the visible light region at an optical path length of 10 mm without dilution) higher than 4.

Each of those troubles is a phenomenon which can occur in actual use environments. A pigment component which has dissolved serves to bond pigment particles to one another to yield larger particles or form a deposit on the inner wall of the nozzle. Thus, storage stability and ejection stability are deteriorated.

<Preparation of Aqueous Dispersion D of Figment-Containing Polymer Particles>

An aqueous dispersion D of pigment-containing polymer particles was produced by the following process.

Copolymer Production Example

Into a reactor were introduced initial feed monomers consisting of 20 parts by weight of methyl ethyl ketone, 7.5 parts by weight of styrene, 3 parts by weight of n-dodecyl methacrylate, 10 parts by weight of N,N-dimethylaminoethyl methacrylate, 20 parts by weight of methoxypolyethylene glycol methacrylate [trade name, NK Ester M40G; manufactured by Shin-Nakamura Chemical Co., Ltd.], 5 parts by weight of styrene macromer [trade name, AS-6 (macromer obtained by styrene homopolymerization; number-average molecular weight, 6,000; polymerizable functional group, methacryloyloxy group); manufactured by Toagosei Chemical Industry Co., Ltd.], and 0.2 parts by weight of mercaptoethanol. Nitrogen gas displacement was sufficiently conducted.

On the other hand, dropping monomers consisting of 7.5 parts by weight of styrene, 5 parts by weight of n-dodecyl methacrylate, 15 parts by weight of N,N-dimethylaminoethyl methacrylate, 20 parts by weight of methoxypolyethylene glycol (4) methacrylate, 5 parts by weight of styrene macromer [trade name, AS-6 (macromer obtained by styrene homopolymerization; number-average molecular weight, 6,000; polymerizable functional group, methacryloyloxy group); manufactured by Toagosei Chemical Industry Co., Ltd.], 1.8 parts by weight of mercaptoethanol, 60 parts by weight of methyl ethyl ketone, and 1.2 parts by weight of 2,2′-azobis(2,4-dimethylvaleronitrile) were introduced into a dropping funnel. Nitrogen displacement was sufficiently conducted.

In a nitrogen atmosphere, the mixture solution in the reactor was heated to 65° C. with stirring and the mixture solution in the dropping funnel was gradually dropped thereinto over 3 hours. Two hours after completion of the dropwise addition, a solution prepared by dissolving 0.3 parts by weight of 2,2′-azobis(2,4-dimethylvaleronitrile) in 5 parts by weight of methyl ethyl ketone (hereinafter referred to as MEK) was added to the reaction mixture. The resultant mixture was aged at 65° C. for 2 hours and then at 70° C. for 2 hours to obtain a copolymer solution.

Part of the copolymer solution in MEK obtained was dried under vacuum at 105° C. for 2 hours to remove the solvent and thereby isolate the copolymer. The weight-average molecular weight thereof was determined by gel permeation chromatography using polystyrene as a reference material and tetrahydrofuran as a solvent. As a result, the weight-average molecular weight thereof was found to be 15,000. The copolymer solution obtained was dried under vacuum to obtain the copolymer.

Process Example D

In 5 parts by weight of MEK was dissolved 5 parts by weight of the copolymer. To this solution were added 20 parts by weight of ion-exchanged water and 5.2 parts by weight of 30% aqueous gluconic acid solution. These ingredients were mixed together by means of an anchor blade for 30 minutes to obtain a milk-white mixture (1). To the mixture (1) obtained was added 15 parts by weight of ion-exchanged water. After the resultant mixture was stirred, the organic solvent and part of the water were removed at 60° C. under reduced pressure to thereby obtain a solvent removal residue having a solid concentration of 20% by weight.

To 33 parts by weight of this solvent removal residue was added 5 parts by weight of the pigment represented by structural formula (A) according to the invention. These ingredients were mixed together for 1 hour by means of a disperser, and the resultant mixture was treated for dispersion by passing it through Microfluidizer (trade name; manufactured by Microfluidics) 5 times at a pressure of 120 MPa. In this treatment, the raw-material feed vessel and treated-material receiver vessel used were kept open, the packings used were not solvent-resistant, and the motor used was not of the explosion-proof type. As a result, no organic-solvent volatilization occurred and the operating efficiency was satisfactorily.

The dispersion obtained was filtered through a membrane filter having a pore size of 1 μm to remove coarse particles. Ion-exchanged water was then added to the dispersion to obtain aqueous dispersion D of pigment-containing polymer particles having a pigment concentration of 10% by weight.

Comparative Process Example D

Five parts by weight of the pigment represented by structural formula (A) according to the invention was added to 46 parts by weight of the mixture (1) obtained in the same manner as in Process Example D which had not undergone solvent removal. The resultant mixture was treated for dispersion by passing it through Microfluidizer (trade name; manufactured by Microfluidics) 5 times at a pressure of 120 MPa. During the dispersion treatment, MEK volatilized from the raw-material feed vessel and treated-material receiver vessel of the Microfluidizer and, hence, the worker put on a mask for protection against organic solvents. Furthermore, the packing of the plunger deteriorated and replacement was hence necessary. Consequently, the operating efficiency was low.

### Examples 1D to 4D and Comparative Examples 1D to 3D

Inks of Examples 1D to 4D and Comparative Examples 1D to 3D were obtained in the same manner as in Examples 1A to 4A and Comparative Examples 1A to 3A, except that aqueous dispersion D of pigment-containing polymer particles, which had been obtained in Process Example D and had a pigment concentration of 10% by weight, was used in place of pigment dispersion A.

In Examples 1D to 4D, the ratio (B/A) of the dissolution amount (B) of the pigment in the liquid medium at 40° C. to the dissolution amount (A) of the pigment in the liquid medium at 25° C. was ascertained to be in the range of from 1 to 10. Absorbance was measured with spectrophotometer U-3300 (manufactured by Hitachi, Ltd.) in a quartz cell having an optical path length of 10 mm.

The ink compositions obtained in Examples 1D to 4D and Comparative Examples 1D to 3D were evaluated for storage stability and ejection stability in the same manners as in Examples 1A to 4A and Comparative Examples 1A to 3A. The evaluation of water resistance described above was further conducted.

The results obtained are summarized in Table 1D.

TABLE 1D

| | Storage Stability | | | | | | | | | |
|---|---|---|---|---|---|---|---|---|---|---|
| | | Percentage | | | | | | | | |
| | | increase in | | | Ejection Stability | | | | Water Resistance | |
| | Dissolution | average | Increase in | Foreign | | | Wetting | | Absorbance | |
| | amount | particle | coarse | matter of 1 | Flight | | around | Foreign | of 25° C. | Blurring in |
| | ratio, B/A | diameter | particles | μm | deflection | Dot missing | nozzle | matter | supernatant | water mark |
| Example 1D | 7.0 | 9% | not occurred | absent | not | not | not | absent | 3.2 | not occurred |
| | | | | | occurred | occurred | occurred | | | |
| Example 2D | 4.2 | 5% | not occurred | absent | not | not | not | absent | 2.5 | not occurred |
| | | | | | occurred | occurred | occurred | | | |
| Example 3D | 2.0 | 2% | not occurred | absent | not | not | not | absent | 2.0 | not occurred |
| | | | | | occurred | occurred | occurred | | | |
| Example 4D | 1.4 | 1% | not occurred | absent | not | not | not | absent | 1.5 | not occurred |
| | | | | | occurred | occurred | occurred | | | |
| Comparative | 12.2 | 48% | occurred | present | occurred | occurred | occurred | present | 6.3 | occurred |
| Example 1D | | | | | | | | | | |
| Comparative | 10.5 | 38% | occurred | present | occurred | occurred | occurred | present | 4.9 | not occurred |
| Example 2D | | | | | | | | | | |
| Comparative | 10.7 | 39% | occurred | present | occurred | occurred | occurred | present | 5.1 | not occurred |
| Example 3D | | | | | | | | | | |

The ink compositions of Examples 1D to 4D gave satisfactory results in each evaluation, showing that these compositions were highly excellent because B/A was in the range of from 1 to 10. The smaller the value of B/A, the better the evaluation results. B/A is preferably from 1 to 5, more preferably from 1 to 2.

The compositions of Comparative Examples 1D to 3D each gave unsatisfactory results in at least one of the evaluations. In the evaluation of storage stability, the average particle diameter increased by more than 20%, and an increase in the amount of course particles and the generation of foreign matter caught by the 1-μm filter were observed. In the evaluation of ejection stability, ink droplet flight deflection and dot missing occurred. In the nozzle surface examination, wetting around the nozzle and foreign-matter deposition within the nozzle were observed. Furthermore, in the evaluation of water resistance, ink blurring was observed in the water mark in the case of the ink composition in which the supernatant had an absorbance (peak absorbance value in the visible light region at an optical path length of 10 mm without dilution) higher than 6.

Each of those troubles is a phenomenon which can occur in actual use environments. A pigment component which has dissolved serves to bond pigment particles to one another to yield larger particles or form a deposit on the inner wall of the nozzle. Thus, storage stability and ejection stability are deteriorated. Furthermore, an increase in pigment dissolution amount resulted in poor water resistance.

Process Example E

An aqueous dispersion E of pigment-containing polymer particles, which had a pigment concentration of 10% by weight, was obtained in the same manner as in Process Example D, except that the pigment represented by general formula (B) wherein R is methyl (2,9-dimethyl) was used in place of the pigment represented by structural formula (A). As in Process Example D, no organic-solvent volatilization occurred during the dispersion treatment and the operating efficiency was satisfactory.

Comparative Process Example E

The same procedure as in Comparative Process Example D was conducted, except that the pigment represented by general formula (B) wherein R is methyl (2,9-dimethyl) was used in place of the pigment represented by structural formula (A). During the dispersion treatment, MEK volatilized from the raw-material feed vessel and treated-material receiver vessel of the Microfluidizer and, hence, the worker put on a mask for protection against organic solvents. Furthermore, the packing of the plunger deteriorated and replacement was hence necessary. Consequently, the operating efficiency was low.

### Examples 1E to 4E and Comparative Examples 1E to 3E

Inks of Examples 1E to 4E and Comparative Examples 1E to 3E were obtained in the same manner as in Examples 1A to 4A and Comparative Examples 1A to 3A, except that aqueous dispersion E of pigment-containing polymer particles, which had been obtained in Process Example E and had a pigment concentration of 10% by weight, was used in place of pigment dispersion A.

In Examples 1E to 4E, the ratio (B/A) of the dissolution amount (B) of the pigment in the liquid medium at 40° C. to the dissolution amount (A) of the pigment in the liquid medium at 25° C. was ascertained to be in the range of from 1 to 10. Absorbance was measured with spectrophotometer U-3300 (manufactured by Hitachi, Ltd.) in a quartz cell having an optical path length of 10 mm.

The ink compositions obtained in Examples 1E to 4E and Comparative Examples 1E to 3E were evaluated for storage stability and ejection stability in the same manners as in Examples 1A to 4A and Comparative Examples 1A to 3A. The evaluation of water resistance described above was further conducted.

The results obtained are summarized in Table 1E.

TABLE 1E

| | Storage Stability | | | | | | | | | |
|---|---|---|---|---|---|---|---|---|---|---|
| | | Percentage | | | | | | | | |
| | | increase in | | | Ejection Stability | | | | Water Resistance | |
| | Dissolution | average | Increase in | Foreign | | | Wetting | | Absorbance | |
| | amount | particle | coarse | matter of 1 | Flight | | around | Foreign | of 25° C. | Blurring in |
| | ratio, B/A | diameter | particles | μm | deflection | Dot missing | nozzle | matter | supernatant | water mark |
| Example 1E | 7.0 | 10% | not occurred | absent | not | not | not | absent | 2.1 | not occurred |
| | | | | | occurred | occurred | occurred | | | |
| Example 2E | 4.2 | 5% | not occurred | absent | not | not | not | absent | 1.6 | not occurred |
| | | | | | occurred | occurred | occurred | | | |
| Example 3E | 2.1 | 3% | not occurred | absent | not | not | not | absent | 1.3 | not occurred |
| | | | | | occurred | occurred | occurred | | | |
| Example 4E | 1.4 | 1% | not occurred | absent | not | not | not | absent | 1.0 | not occurred |
| | | | | | occurred | occurred | occurred | | | |
| Comparative | 12.5 | 48% | occurred | present | occurred | occurred | occurred | present | 5.2 | occurred |
| Example 1E | | | | | | | | | | |
| Comparative | 10.3 | 38% | occurred | present | occurred | occurred | occurred | present | 4.1 | not occurred |
| Example 2E | | | | | | | | | | |
| Comparative | 10.8 | 39% | occurred | present | occurred | occurred | occurred | present | 4.2 | not occurred |
| Example 3E | | | | | | | | | | |

The ink compositions of Examples 1E to 4E gave satisfactory results in each evaluation, showing that these compositions were highly excellent because B/A was in the range of from 1 to 10. The smaller the value of B/A, the better the evaluation results. B/A is preferably from 1 to 5, more preferably from 1 to 2.

The compositions of Comparative Examples 1E to 3E each gave unsatisfactory results in at least one of the evaluations. In the evaluation of storage stability, the average particle diameter increased by more than 20%, and an increase in the amount of course particles and the generation of foreign matter caught by the 1-μm filter were observed. In the evaluation of ejection stability, ink droplet flight deflection and dot missing occurred. In the nozzle surface examination, wetting around the nozzle and foreign-matter deposition within the nozzle were observed. Furthermore, in the evaluation of water resistance, ink blurring was observed in the water mark in the case of the ink composition in which the supernatant had an absorbance (peak absorbance value in the visible light region at an optical path length of 10 mm without dilution) higher than 5.

Each of those troubles is a phenomenon which can occur in actual use environments. A pigment component which has dissolved serves to bond pigment particles to one another to yield larger particles or form a deposit on the inner wall of the nozzle. Thus, storage stability and ejection stability are deteriorated. Furthermore, an increase in pigment dissolution amount resulted in poor water resistance.

Process Example F

An aqueous dispersion F of pigment-containing polymer particles, which had a pigment concentration of 10% by weight, was obtained in the same manner as in Process Example D, except that the pigment represented by general formula (C) wherein n is 0 was used in place of the pigment represented by structural formula (A). As in Process Example D, no organic-solvent volatilization occurred during the dispersion treatment and the operating efficiency was satisfactory.

Comparative Process Example F

The same procedure as in Comparative Process Example D was conducted, except that the pigment represented by general formula (C) wherein n is 0 was used in place of the pigment represented by structural formula (A). During the dispersion treatment, MEK volatilized from the raw-material feed vessel and treated-material receiver vessel of the Microfluidizer and, hence, the worker put on a mask for protection against organic solvents. Furthermore, the packing of the plunger deteriorated and replacement was hence necessary. Consequently, the operating efficiency was low.

### Examples 1F to 4F and Comparative Examples 1F to 3F

Inks of Examples 1F to 4F and Comparative Examples 1F to 3F were obtained in the same manner as in Examples 1A to 4A and Comparative Examples 1A to 3A, except that aqueous dispersion F of pigment-containing polymer particles, which had been obtained in Process Example F and had a pigment concentration of 10% by weight, was used in place of pigment dispersion A.

In Examples 1F to 4F, the ratio (B/A) of the dissolution amount (B) of the pigment in the liquid medium at 40° C. to the dissolution amount (A) of the pigment in the liquid medium at 25° C. was ascertained to be in the range of from 1 to 10. Absorbance was measured with spectrophotometer U-3300 (manufactured by Hitachi, Ltd.) in a quartz cell having an optical path length of 10 mm.

The ink compositions obtained in Examples 1F to 4F and Comparative Examples 1F to 3F were evaluated for storage stability and ejection stability in the same manners as in Examples 1A to 4A and Comparative Examples 1A to 3A. The evaluation of water resistance described above was further conducted.

The results obtained are summarized in Table 1F.

TABLE 1F

| | Storage Stability | | | | | | | | | |
|---|---|---|---|---|---|---|---|---|---|---|
| | | Percentage | | | | | | | | |
| | | increase in | | | Ejection Stability | | | | Water Resistance | |
| | Dissolution | average | Increase in | Foreign | | | Wetting | | Absorbance | |
| | amount | particle | coarse | matter of 1 | Flight | | around | Foreign | of 25° C. | Blurring in |
| | ratio, B/A | diameter | particles | μm | deflection | Dot missing | nozzle | matter | supernatant | water mark |
| Example 1F | 7.3 | 10% | not occurred | absent | not | not | not | absent | 1.9 | not occurred |
| | | | | | occurred | occurred | occurred | | | |
| Example 2F | 4.1 | 5% | not occurred | absent | not | not | not | absent | 1.4 | not occurred |
| | | | | | occurred | occurred | occurred | | | |
| Example 3F | 2.3 | 3% | not occurred | absent | not | not | not | absent | 1.1 | not occurred |
| | | | | | occurred | occurred | occurred | | | |
| Example 4F | 1.4 | 1% | not occurred | absent | not | not | not | absent | 0.8 | not occurred |
| | | | | | occurred | occurred | occurred | | | |
| Comparative | 12.3 | 48% | occurred | present | occurred | occurred | occurred | present | 4.4 | occurred |
| Example 1F | | | | | | | | | | |
| Comparative | 10.7 | 37% | occurred | present | occurred | occurred | occurred | present | 3.4 | not occurred |
| Example 2F | | | | | | | | | | |
| Comparative | 10.9 | 39% | occurred | present | occurred | occurred | occurred | present | 3.5 | not occurred |
| Example 3F | | | | | | | | | | |

The ink compositions of Examples 1F to 4F gave satisfactory results in each evaluation, showing that these compositions were highly excellent because B/A was in the range of from 1 to 10. The smaller the value of B/A, the better the evaluation results. B/A is preferably from 1 to 5, more preferably from 1 to 2.

The compositions of Comparative Examples 1F to 3F each gave unsatisfactory results in at least one of the evaluations. In the evaluation of storage stability, the average particle diameter increased by more than 20%, and an increase in the amount of course particles and the generation of foreign matter caught by the 1-μm filter were observed. In the evaluation of ejection stability, ink droplet flight deflection and dot missing occurred. In the nozzle surface examination, wetting around the nozzle and foreign-matter deposition within the nozzle were observed. Furthermore, in the evaluation of water resistance, ink blurring was observed in the water mark in the case of the ink composition in which the supernatant had an absorbance (peak absorbance value in the visible light region at an optical path length of 10 mm without dilution) higher than 6.

Each of those troubles is a phenomenon which can occur in actual use environments. A pigment component which has dissolved serves to bond pigment particles to one another to yield larger particles or form a deposit on the inner wall of the nozzle. Thus, storage stability and ejection stability are deteriorated. Furthermore, an increase in pigment dissolution amount resulted in poor water resistance.

As described above, according to the invention, an aqueous ink composition can be obtained which takes advantage of the excellent properties of a pigment and has satisfactory storage stability and ejection stability, the attainment of which has been a subject for pigment inks. An ink jet recording process can also be obtained.

This application is based on Japanese Patent Applications Nos. 2002-67718 (filed Mar. 12, 2002), 2002-67728 (filed Mar. 12, 2002), 2002-84349 (filed Mar. 25, 2002), 2002-188603 (filed Jun. 27, 2002), 2002-188604 (filed Jun. 27, 2002), and 2002-188605 (filed Jun. 27, 2002), the contents thereof being incorporated herein by reference.

While the invention has been described in detail and with reference to specific embodiments thereof, it will be apparent to one skilled in the art that various changes and modifications can be made therein without departing from the spirit and scope thereof.

What is claimed is:

1. An aqueous ink composition which contains at least (a) a glycol ether type water-soluble organic solvent, (b) an acetylene glycol type surfactant and (c) a pigment, wherein the pigment has a ratio (B/A) of its dissolution amount (B) in the ink liquid medium at 40° C. to its dissolution amount (A) in the ink liquid medium at 25° C. of from 1 to 10.

2. The aqueous ink composition of claim 1, wherein the pigment is represented by the following structural formula (A):

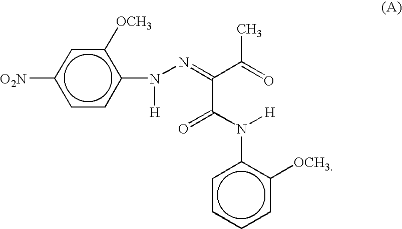

3. The aqueous ink composition of claim 1, wherein the pigment is represented by the following structural formula (B): 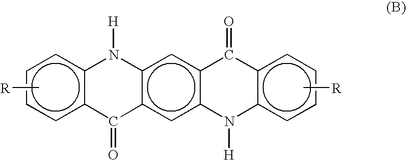
wherein R represents a hydrogen atom, a methyl group, or a chlorine atom.

4. The aqueous ink composition of claim 1, wherein the pigment is represented by the following general formula (C): 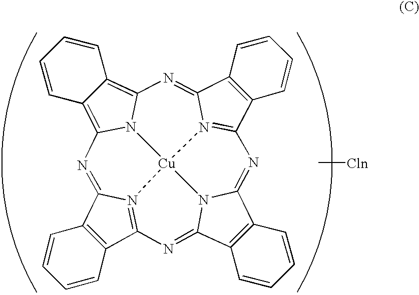
wherein n representing the number of chloride atoms, is from 0 to 16.

5. The aqueous ink composition of claim 2, which contains the pigment in the form of an aqueous dispersion of pigment-containing polymer particles, the aqueous dispersion being obtained by a process comprising: (I) a step of removing an organic solvent from a mixture (1) comprising an organic solvent solution of a polymer, water and optionally a neutralizing agent; (II) a step of subjecting the residue resulting from the solvent removal in step (I) to a dispersion treatment; and further adding the compound represented by general formula (A) to either the mixture (1) or the residue resulting from the solvent removal.

6. The aqueous ink composition of claim 3, which contains the pigment in the form of an aqueous dispersion of pigment-containing polymer particles, the aqueous dispersion being obtained by a process comprising: (I) a step of removing an organic solvent from a mixture (1) comprising an organic solvent solution of a polymer, water and optionally a neutralizing agent; (II) a step of subjecting the residue resulting from the solvent removal in step (I) to a dispersion treatment; and further adding the compound represented by general formula (B) to either the mixture (1) or the residue resulting from the solvent removal.

7. The aqueous ink composition of claim 4, which contains the pigment in the form of an aqueous dispersion of pigment-containing polymer particles, the aqueous dispersion being obtained by a process comprising: (I) a step of removing an organic solvent from a mixture (1) comprising an organic solvent solution of a polymer, water and optionally a neutralizing agent; (II) a step of subjecting the residue resulting from the solvent removal in step (I) to a dispersion treatment; and further adding the compound represented by general formula (C) to either the mixture (1) or the residue resulting from the solvent removal.

8. The aqueous ink composition of claim 4, wherein the ink composition, when the solid matter contained in the aqueous ink composition at 25° C. is sedimented by centrifuging, gives a supernatant having an absorbance (peak absorbance value in the visible light region at an optical path length of 10 mm without dilution) of 4 or lower.

9. The aqueous ink composition of claim 5, wherein the ink composition, when the solid matter contained in the aqueous ink composition at 25° C. is sedimented by centrifuging, gives a supernatant having an absorbance (peak absorbance value in the visible light region at an optical path length of 10 mm without dilution) of 6 or lower.

10. The aqueous ink composition of claim 6, wherein the ink composition, when the solid matter contained in the aqueous ink composition at 25° C. is sedimented by centrifuging, gives a supernatant having an absorbance (peak absorbance value in the visible light region at an optical path length of 10 mm without dilution) of 5 or lower.

11. The aqueous ink composition of claim 7, wherein the ink composition, when the solid matter contained in the aqueous ink composition at 25° C. is sedimented by centrifuging, gives a supernatant having an absorbance (peak absorbance value in the visible light region at an optical path length of 10 mm without dilution) of 4 or lower.

12. An ink jet recording process which comprises ejecting an ink composition in the form of droplets from a minute nozzle to adhere the droplets to a recording medium, wherein the ink composition is an aqueous ink composition of any one of claims 1 to 11.
